(19) United States
(12) Patent Application Publication
(10) Pub. No.: US 2021/0118028 A1
(43) Pub. Date: Apr. 22, 2021

(54) INFORMATION PROCESSING METHOD, COMPUTER-READABLE NON-TRANSITORY STORAGE MEDIUM STORING PROGRAM, AND INFORMATION PROCESSING DEVICE

(71) Applicant: MERCARI, INC., Tokyo (JP)

(72) Inventors: Ryota TAJIMA, Tokyo (JP); Yuki YODA, Tokyo (JP); Kaori TOTSUKA, Tokyo (JP); Yasuo HISHII, Tokyo (JP)

(21) Appl. No.: 17/063,594

(22) Filed: Oct. 5, 2020

(30) Foreign Application Priority Data
Oct. 16, 2019 (JP) 2019-189690

(51) Int. Cl. G06Q 30/06; G06Q 30/02

(52) U.S. Cl. CPC G06Q 30/0611; G06Q 30/0609; G06Q 30/0206; G06Q 30/0201

(57) ABSTRACT

The purpose of the prevent invention is to request listing for a product owned by any of others on an e-commerce platform. Provided is an information processing method wherein one or more processors included in an information processing device perform the processes of: acquiring a product request made from another user for an unlisted first product on an e-commerce platform that is the first product owned by a first user; associating the product request with information on the first product; notifying the information processing device used by the first user of information indicating that there has been made the product request for the first product; and performing listing processing of the first product on the e-commerce platform in the case where there is a listing order for the first product from the first user.

### CROSS REFERENCE TO RELATED APPLICATION

The present application is based on and claims priority under 35 U. S. C. § 119 to Japanese Patent Application No. 2019-189690, filed on Oct. 16, 2019, the content of which is incorporated herein by reference in its entirety.

### BACKGROUND

### Field

This disclosure relates to an information processing method, a computer-readable non-transitory storage medium storing a program, and an information processing device.

### Description of Related Art

A system for mediating individual sales has been published on an e-commerce platform such as a customer-to-customer (C-to-C) marketplace (for example, refer to Japanese Patent Application Laid-Open No. 2001-167163).

### SUMMARY

On an e-commerce platform, however, even if a user wants to purchase a product, the user may lose the opportunity and cannot purchase the desired product. In this case, the user would have to wait until the same product is listed for sale. Therefore, even though the user knew that someone else owned it, the user could not take action on the e-commerce platform for that product.

An object of the present disclosure is to provide an information processing method, a program, and an information processing device that enable a person to request a product to be listed for sale with respect to a product owned by another person, who bought the product, on an e-commerce platform.

According to an aspect of the present disclosure, there is provided an information processing method wherein one or more processors included in an information processing device perform the processes of: acquiring a product request made from another user for an unlisted first product on an e-commerce platform that is the first product owned by a first user; associating the product request with information on the first product; notifying the information processing device used by the first user of information indicating that there has been made the product request for the first product; and performing listing processing of the first product on the e-commerce platform in the case where there is a listing order for the first product from the first user.

The disclosed technique enables requests for listings of products owned by others for sale on the e-commerce platform.

### BRIEF DESCRIPTION OF DRAWINGS

FIG. 1 is a diagram illustrating each configuration example of an information processing system 1 in an embodiment.

FIG. 2 is a block diagram illustrating an example of a user terminal 10 according to an embodiment.

FIG. 3 is a block diagram illustrating an example of a server 20 according to an embodiment.

FIG. 4 is a diagram illustrating an example of user data 233 according to an embodiment.

FIG. 5 is a diagram illustrating an example of transaction data 234 according to an embodiment.

FIG. 6 is a diagram illustrating an example of inventory list data 235 according to an embodiment.

FIG. 7 is a flowchart illustrating an example of processing related to the sending of a product request according to an embodiment.

FIG. 8 is a flowchart illustrating an example of processing related to the sending of a product request according to an embodiment.

FIG. 9 is a flowchart illustrating an example of processing related to the sending of a product request according to an embodiment.

FIG. 10 is a flowchart illustrating an example of processing related to a result of a product request according to an embodiment.

FIG. 11 is a flowchart illustrating an example of processing related to a result of a product request according to an embodiment.

FIG. 12 is a flowchart illustrating an example of processing related to reception of a product request according to an embodiment.

FIG. 13 is a flowchart illustrating an example of processing related to reception of a product request according to an embodiment.

FIG. 14 is a flowchart illustrating an example of processing related to reception of a product request according to an embodiment.

FIG. 15 is a diagram illustrating an example of a sample screen displaying product request buttons according to an embodiment.

FIG. 16 is a diagram illustrating a sample screen displaying product request buttons according to an embodiment.

FIG. 17 is a diagram illustrating a sample screen displaying product request buttons according to an embodiment.

FIG. 18 is a diagram illustrating a screen transition example at the time of issuing a product request according to an embodiment.

FIG. 19 is a diagram illustrating a screen transition example in the case where a product request according to an embodiment is approved.

FIG. 20 is a diagram illustrating a screen transition example in the case where a product request according to an embodiment is abandoned.

FIG. 21 is a diagram illustrating a screen transition example in the case where a product request according to an embodiment is received.

FIG. 22 is a diagram illustrating a screen transition example in the case where a product request according to an embodiment is received.

FIG. 23 is a diagram illustrating a screen transition example in the case where a product request according to an embodiment is received.

FIG. 24 is a diagram illustrating a screen transition example in the case where a product request according to an embodiment is received.

### DETAILED DESCRIPTION

Hereinafter, embodiments of the present disclosure will be described in detail with reference to the drawings. In the description, the same elements will be denoted by the same reference numerals, without redundant description.

### Embodiments

Embodiments describe a device and/or system that allows a user to make a request for listing a product owned by a predetermined user for sale. For example, there is provided a mechanism that allows a user who wants to purchase a sold-out product to request that the product to be listed for sale on an e-commerce platform. In the following, a request to invite another person to list a product for sale is also referred to as “product request” or “listing request.” This enables an increase in the possibility that unlisted products owned by others are listed on the e-commerce platform, thereby promoting the distribution of products that have been successfully completed in sales transaction.

System Application Example

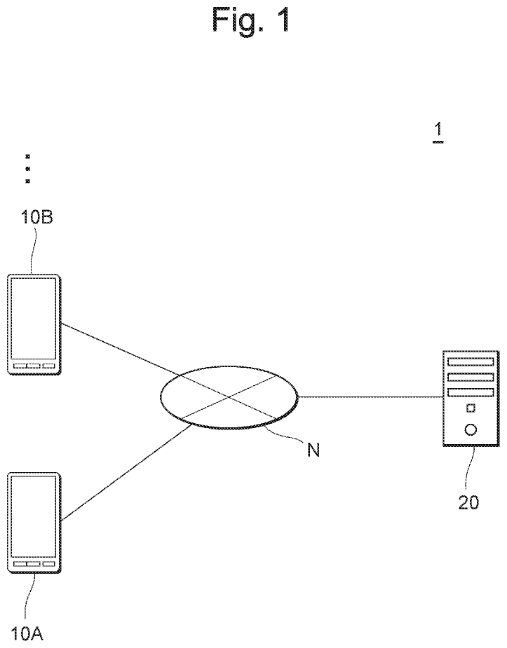

FIG. 1 is a diagram illustrating each configuration example of an information processing system 1 in an embodiment. In the example illustrated in FIG. 1, a server 20 that manages an e-commerce platform and each information processing device 10A, 10B, or the like used by each user are connected via a network N. Note that an arbitrary number of information processing devices 10A, 10B, and the like are connected to the network N.

The information processing devices 10A and 10B are, for example, smartphones, mobile phones (feature phones), computers, PDAs (personal digital assistants), or the like and have an imaging device, like a camera function, built in or externally attached. The information processing devices 10A and 10B are also referred to as information processing devices 10 or user terminals 10, unless otherwise specified.

The information processing device 20 is, for example, a server and may be composed of one or more devices. In addition, the information processing device 20 manages the e-commerce platform and manages the product requests for the products owned by predetermined users. Hereinafter, the information processing device 20 is also referred to as “server 20.”

In the example illustrated in FIG. 1, it is assumed that a user (second user) who uses the user terminal 10 is browsing a predetermined page of the e-commerce platform and then finds a product that the user wants to purchase, which is a product (first product) owned by a predetermined user (first user). In this case, the second user requests that the first product be listed for sale by using a function of the e-commerce platform. For example, the user terminal 10 detects a product request button pressed by the second user and sends the product request for the first product to the server 20.

Upon receiving the product request from the user terminal 10, the server 20 notifies the user terminal 10 used by the first user of the product request having been made for the first product at a predetermined timing in association with the product request having been made for the first product. The server 20 determines whether to list the product or to reject the product request according to the operation of the first user and performs the subsequent processing. This enables the user to be provided with a mechanism for requesting that a predetermined user should list an unlisted product owned by the predetermined user.

Example of Configuration

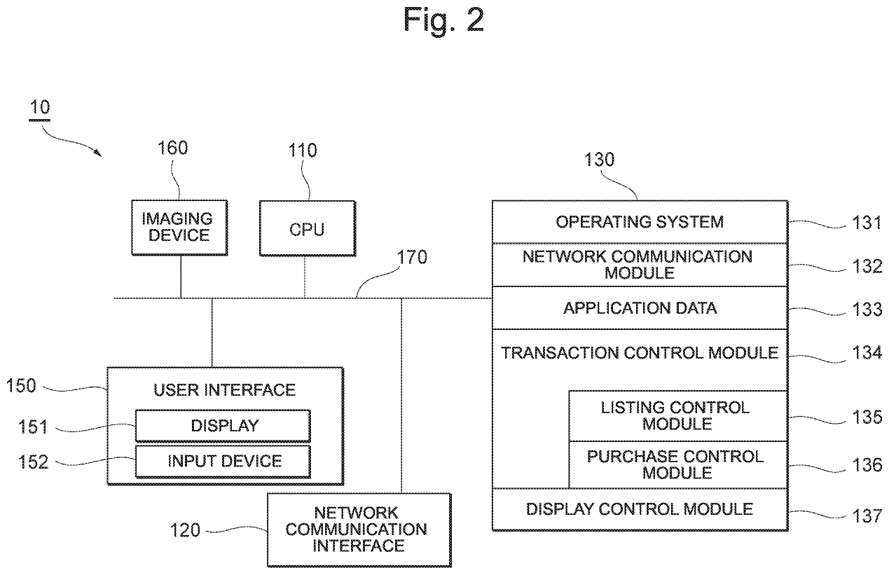

FIG. 2 is a block diagram illustrating an example of the user terminal 10 according to the embodiment. The user terminal 10 includes one or more processing devices (CPU) 110, one or more network communication interfaces 120, a memory 130, a user interface 150, an imaging device 160, and one or more communication buses 170 for interconnecting these components.

The user interface 150 is, for example, a user interface 150 that includes a display device 151 and an input device (such as a keyboard and/or mouse or some other pointing device) 152. The user interface 150 may be a touch panel. The imaging device 160 images, for example, a product and then stores the captured image in the memory 130.

The memory 130 is a high-speed random access memory such as, for example, a DRAM, a SRAM, a DDR RAM, or any other random access solid state storage device, and also may be one or more magnetic disk storage devices, optical disk storage devices, flash memory devices, or a non-volatile memory such as another non-volatile solid-state memory device.

Further, as another example of the memory 130, one or more storage devices installed remotely from the CPU 110 may be used. In one embodiment, the memory 130 stores the following programs, modules, and data structures, or subsets thereof.

The operating system 131 includes, for example, procedures for handling various basic system services and performing tasks by using hardware.

The network communication module 132 is used, for example, to connect the user terminal 10 to another computer via one or more network communication interfaces 120 and via one or more communication networks such as the Internet, other wide area networks, local area networks, or metropolitan area networks.

The application data 133 includes data processed when a user uses the e-commerce platform. For example, the application data 133 includes user information and information acquired from the server 20. Specifically, the application data 133 may include product information and the like provided when browsing products using the e-commerce platform.

A transaction control module 134 controls transactions such as buying and selling products on the e-commerce platform provided by the server 20. For example, the transaction control module 134 performs processing related to the product request described above. Specifically, upon detecting the user operation of a product request, the transaction control module 134 sends the product request and product identification information (for example, product ID) indicating the requested first product to the server 20. In addition, upon receiving a notification, from the server 20, indicating that the product request has been made from the user (second user) who wants to purchase the first product, the transaction control module 134 controls an operation to inform the first user as to it by displaying the notification content on the screen, for example.

In addition, the transaction control module 134 includes a listing control module 135 that performs processing in listing a product and a purchase control module 136 that performs processing in purchasing the product.

The listing control module 135 controls the processing performed when the user lists a product. For example, the listing control module 135 acquires the product information on the product to be listed and controls the product information to be sent to the server 20. The product to be listed is available for sale on the e-commerce platform, and the product information includes image data of the product and information for describing the product such as the name, category, brand, size, condition, price, and the like of the product.

The purchase control module 136 controls processing performed when a user purchases a product. For example, the purchase control module 136 controls an interaction with an exhibitor until the end of the transaction upon detecting a product listed on the e-commerce platform in accordance with a user operation. Specifically, the purchase control module 136 controls the operations to exchange messages regarding a price negotiation and other negotiations of a product delivery method and the like.

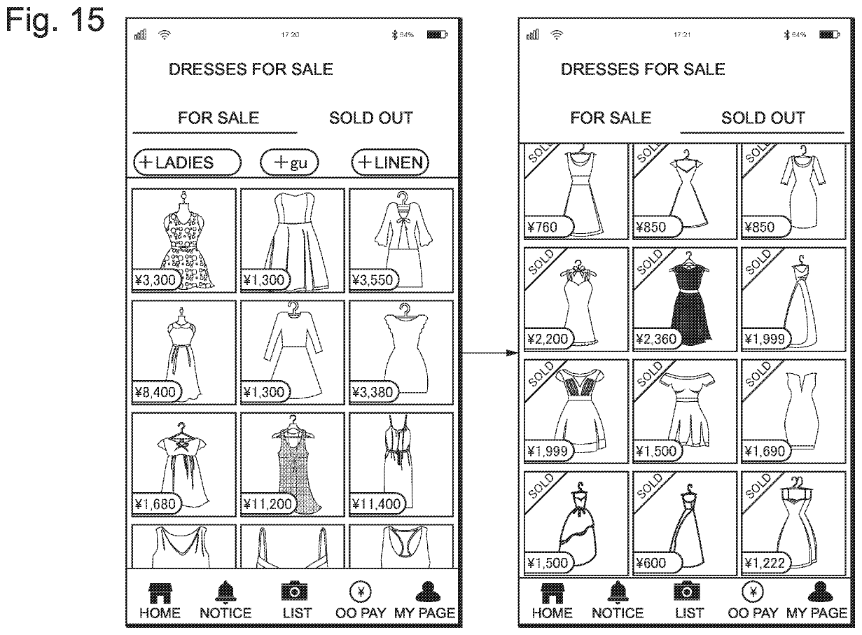

The display control module 137 controls the display 151 to display a screen provided in the e-commerce platform. For example, the display control module 137 appropriately controls the display of the screen related to listing, browsing, and purchasing of products. In addition, the display control module 137 displays UI components (such as, for example, buttons and check boxes) related to the product request on the screen and displays a notification of accepting the product request and the like on the screen. Examples of the screen displayed by the display control module 137 will be described later with reference to FIGS. 15 to 24.

One or more processing devices (CPU) 110 read out and execute respective modules from the memory 130 as needed. For example, one or more processing devices (CPU) 110 may configure a communication unit by executing a network communication module 132 stored in the memory 130. In addition, one or more processing devices (CPU) 110 may execute the transaction control module 134, the listing control module 135, the purchase control module 136, and the display control module 137 stored in the memory 130 to configure a transaction control unit, a listing control unit, a purchase control unit, and a display control unit. Further, each of the processes of the transaction control module 134, the listing control module 135, the purchase control module 136, and the display control module 137 may be performed by one or more processing devices (CPU) 110.

In another embodiment, the transaction control module 134, the listing control module 135, the purchase control module 136, and the display control module 137 may be standalone applications stored in the memory 130 of the user terminal 10. Although not particularly limited, the standalone applications include a transaction control application, a purchase application, a listing control application, and a display control application. In yet another embodiment, the transaction control module 134, the listing control module 135, the purchase control module 136, and the display control module 137 may be add-ons or plug-ins added to another application.

Each of the above elements may be stored in one or more of the aforementioned storage devices. The above modules correspond to respective sets of instructions for use in performing the functions described above. The modules or programs (in other words, sets of instructions) in the above need not be implemented as separate software programs, procedures, or modules, and thus different subsets of these modules may be combined in different embodiments, or alternatively, may be reconfigured. In some embodiments, the memory 130 may store a subset of the modules and data structures described above. Furthermore, the memory 130 may store additional modules and data structures not described above.

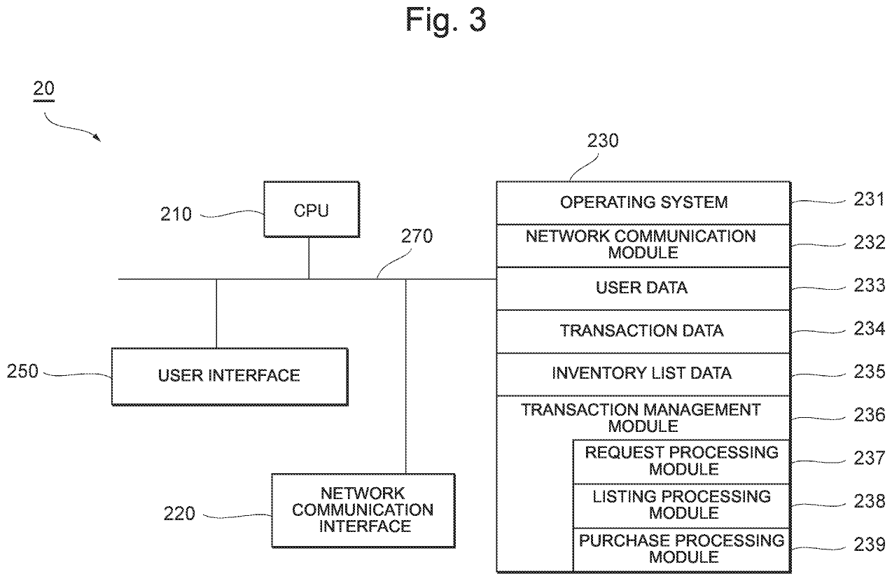

FIG. 3 is a block diagram illustrating an example of the server 20 according to the embodiment. The server 20 includes one or more processing devices (CPUs) 210, one or more network communication interfaces 220, a memory 230, and one or more communication buses 270 for interconnecting these components.

The server 20 may optionally include a user interface 250. The user interface 250 may be a display device (not illustrated) or an input device (not illustrated) such as a keyboard and/or a mouse, or some other pointing device.

The memory 230 is a high speed random access memory, such as, for example, a DRAM, a SRAM, a DDR RAM, or any other random access solid state storage device, and also may be one or more magnetic disk storage devices, optical disk storage devices, flash memory devices, or a non-volatile memory such as another non-volatile solid-state memory device.

Further, as another example of the memory 230, one or more storage devices installed remotely from the CPU 210 may be used. In one embodiment, the memory 230 stores the following programs, modules, and data structures, or subsets thereof.

The operating system 231 includes, for example, procedures for handling various basic system services and performing tasks by using hardware.

The network communication module 232 is used, for example, to connect the server 20 to other computers via one or more network communication interfaces 220 and via one or more communication networks such as the Internet, other wide area networks, local area networks, metropolitan area networks, and the like.

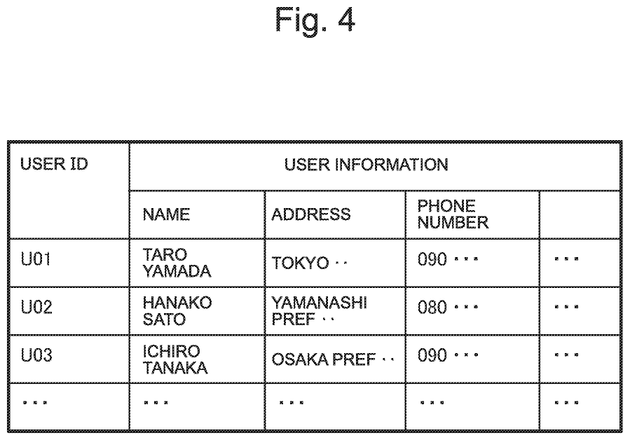

User data 233 includes user information for using the e-commerce platform. For example, the user data 233 includes a user name, an address, a telephone number, and the like in association with each user ID. The user data 233 will be described later with reference to FIG. 4.

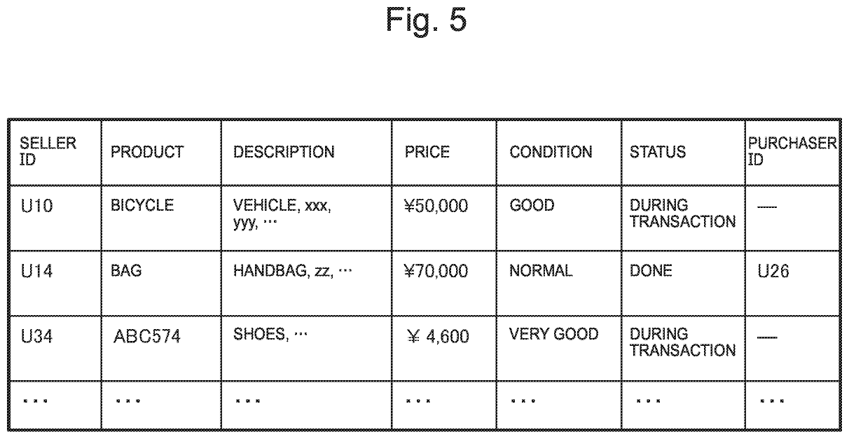

The transaction data 234 includes transaction information of a product registered in the e-commerce platform. For example, the transaction data 234 includes a seller ID (exhibitor ID), a product (or a product ID or the like), a product description (a part of product information), a price, a condition, a status indicating a transaction state, a purchaser ID, and the like for each product that was listed in the past. The transaction data 234 will be described later with reference to FIG. 5.

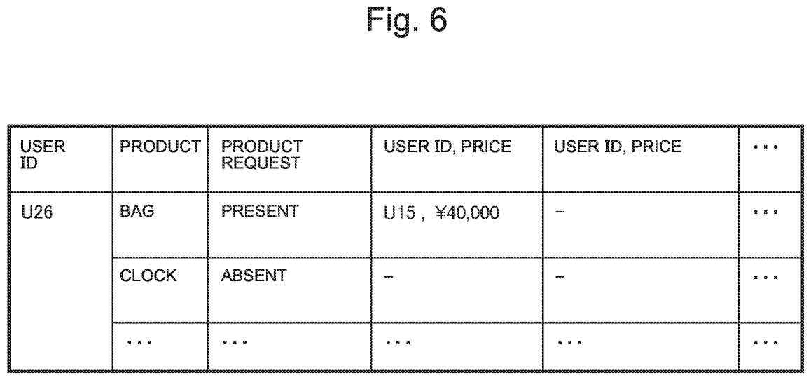

The inventory list data 235 includes a list indicating unlisted products owned by respective users. The inventory list data 235 includes, for each user ID, a product (or a product ID or the like), the presence or absence of a product request, user IDs according to the number of product requests, a price, and the like. The inventory list data 235 will be described later with reference to FIG. 6.

A transaction management module 236 manages the purchase and sale processing of products on the e-commerce platform. For example, the transaction management module 236 has a request processing module 237 that performs processing related to a product request, a listing processing module 238 that performs processing at the time of listing, and a purchase processing module 239 that performs processing at the time of purchase.

The request processing module 237 acquires a product request from another user (for example, the second user) for an unlisted first product in the e-commerce platform, which is the first product owned by the first user, via the network communication module 232. For example, the request processing module 237 acquires a product request sent from the user terminal 10 used by the second user and information that identifies the product (such as a product ID).

The request processing module 237 associates the acquired product request with the information on the first product. For example, the request processing module 237 associates information indicating that the product request has been made with the product identification information for identifying the first product and with the product information or the like. As a specific example, the request processing module 237 associates the presence or absence of a product request with the product identification information included in the inventory list data 235. This allows the server 20 to manage which product is requested to be listed.

The request processing module 237 notifies the information processing device used by the first user of information indicating that the first product has been requested to be listed. For example, the request processing module 237 searches the inventory list data 235 on the basis of the product ID acquired with the product request, and identifies the user ID associated with this product ID. The request processing module 237 sends a notification indicating that the product request has been accepted to the user terminal 10 used by the first user indicated by the specified user ID, via the network communication module 232.

The listing processing module 238 performs the listing processing for the product on the e-commerce platform. For example, the listing processing module 238 performs the listing processing for the first product on the e-commerce platform in the case of receiving a notification that listing the product is approved (listing order) from the first user who was notified of the acceptance of the product request.

This enables a user to be provided with a mechanism for requesting the listing of unlisted products owned by others. It also increases the likelihood that unlisted products owned by others will be listed on the e-commerce platform and promotes the distribution of products that have been successfully completed in sales transaction. In addition, the user who makes a product request does not need to check whether or not a desired product is listed on the e-commerce platform each time, and as a result, the number of accesses to the server 20 is reduced, thereby streamlining the processing on the server 20 side and enabling a reduction in the load on the communication band.

Upon acquiring a purchase request for a predetermined product from the user, the purchase processing module 239 performs a series of purchase processes such as starting a transaction with the user who listed the product, managing the shipment of the product, and setting the evaluation of both parties when the acceptance is confirmed.

In addition, the first product for which a product request has been made may include a product purchased by the first user from the e-commerce platform (also referred to as “first e-commerce platform”) managed by the server 20 or from another e-commerce platform (also referred to as “second e-commerce platform”). For example, a product purchased by using the first e-commerce platform may be automatically registered in the inventory list data 235, and a product purchased by using the second e-commerce platform may be registered by a user operation.

Thus, for the product purchased on the first e-commerce platform, the server 20 originally manages the data related to that product and therefore is able to easily build a mechanism for making a product request. In addition, making it possible to register products purchased on the second e-commerce platform, for example, in the inventory list data 235, enables an increase in the number of various products listed and enables promotion in the distribution of products.

The listing processing module 238 may use at least a part of the product information associated with the first product when the first user purchased the first product on the first e-commerce platform, as the listing information for the first product. For example, the listing processing module 238 may divert the product information set by others, for example, the user who listed the first product, when the first user who has accepted the product request lists the product.

Thus, diverting the product information set by another person enables the time and effort for listing to be saved. The listing processing module 238 may also limit product information to be diverted. For example, the product information to be diverted may include the description of the product and information that does not change due to use such as the category, size, and the like. On the other hand, information newly set by the first user may include the image of the product, the condition of the product, and the delivery and/or other information. Thereby, even in the case where the product information of another person is diverted, setting the latest information of the product enables the latest condition of the product to be set at the time of listing.

Further, the request processing module 237 may further notify the user terminal 10 of first price information indicating a desired price at the time of listing for the first product. For example, the request processing module 237 sends the first price information indicating the price set by the second user or the price set by the server 20 (the price determined based on the market price or the like of the product) to the user terminal 10.

Thereby, sending the information of the desired price of the first product along with the notification of accepting the product request enables the first user who owns the first product to use the price as information for making a decision on listing and prompts the first user to list the product.

Further, in the case of setting the desired price to be notified to the first user, the request processing module 237 may change the desired price according to the period after the first user purchases the first product. For example, the request processing module 237 calculates the period (calculation period) from the date and time when the first user purchases the first product by using the first e-commerce platform to the date and time when the product request is accepted and changes the desired price according to the calculation period. Specifically, the request processing module 237 may calculate the desired price as follows:

Calculation period<Three days: Desired price=Price at which the first user purchased the product×1.2

Three days≤Calculation period<Seven days: Desired price=Price at which the first user purchased the product×1.0

Calculation period≥Seven days: Desired price=Price at which the first user purchased the product×0.8,

where the threshold values for the calculation periods and the coefficients for the desired price can be changed as appropriate.

As a result, expressing the level of needs for the first product by using the calculation period enables the level of needs to be reflected in the price. The request processing module 237 may change the desired price according to the number of product requests. For example, the desired price may be set higher as the number of product requests increases.

Further, the request processing module 237 may acquire the second price information indicating the user's desired price together with the product request. The user's desired price may be input by the second user when instructing the product request.

At this time, the request processing module 237 may notify the first user of information indicating that a product request has been made in the case where the user's desired price is equal to or more than the desired price set by the server 20. For example, the request processing module 237 compares the calculated desired price with the user's desired price in the case where the user's desired price is set in the product request. If the user's desired price is equal to or more than the desired price, the request processing module 237 notifies the first user of the acceptance of the product request since the second user who made the product request is more likely to purchase the product.

This allows the user to set the suggested purchase price for the product when making a product request. As a result, the server 20 is able to notify the first user of the acceptance of the product request at an appropriate timing by comparing the two prices in the case of calculating the desired price of the first product.

In addition, the request processing module 237 may acquire a product request from one or more other users until the first user approves the product request for the first product. For example, the request processing module 237 may acquire a plurality of product requests from one user, or may acquire a product request from each of the plurality of users.

This makes it possible to presume the purchase needs for the first product, and as the number of product requests increases, the first user is able to know how easy it is for the first user to sell the product when it is listed. In addition, the server 20 is able to notify the first user of the information related to the number of product requests so as to prompt the first user to list the product, thereby promoting the distribution of the product.

Further, in the case where the first user approves the product request for the first product. the request processing module 237 may notify each information processing device, which is used by each user associated with the first product as a user who is interested in the first product, of the information related to the listing of the first product. For example, in the case of detecting that the first user lists the first product, the request processing module 237 sets the users who made the product requests, “like,” and the like and then notifies the respective user terminals 10 used by the users who expressed an interest in the first product of the information indicating that the first product has been listed. The “like” settings include those set when the first product was listed on the first e-commerce platform before the first user purchased the first product.

Thus, the users interested in the first product are notified of that the first product is listed when the first user lists the first product, thereby increasing the probability that the first product is successfully completed in an early stage.

Furthermore, in the case where an unlisted first product is displayed on another information processing device (user terminal 10) used by another user (second user), the request processing module 237 may perform control to display a UI component (a request button or the like) that enables the acceptance of the product request on another information processing device. For example, the request processing module 237 causes request buttons to be displayed in association with products included in the sold-out tab prepared by the e-commerce platform, in the list screen of products with “likes” set, or in the list screen or the like of products that the user viewed or the like and could not purchase in the past.

This allows the user to easily make a product request for an unlisted desired product. In addition, it enables the UI components that enables acceptance of product requests to be displayed on various screens.

The listing processing module 238 may also include completing a transaction for the first product with another user (second user) in the case where there is a listing order for the product from the first user. For example, the request processing module 237 notifies the second user of requesting the second user to promise to purchase at the time of making the product request, and if accepted, the product request may be allowed to be acquired. At this time, the listing processing module 238 accepts the listing order, completes the transaction for this product, and then notifies the first user and the second user of the information regarding the completion of the transaction.

Thus, the product request is easily made by causing the second user to promise the purchase when the second user makes the product request. Furthermore, when the first user approves the product request, the request processing module 237 may allow the first user to select whether to perform normal listing processing or to perform listing processing by completing the transaction with pre-checking out.

Moreover, the request processing module 237 may set the upper limit of the number of product requests to be acquired. For example, the request processing module 237 inhibits the acceptance of product requests whose number exceeds the upper limit.

This enables product requests to be prevented from being acquired more than necessary and enables a reduction in processing related to product requests. As a result, the processing of the server 20 can be made more efficient.

Moreover, the request processing module 237 may give benefit information to the second user who has instructed a product request or to the first user who has approved the product request. For example, the request processing module 237 may give points usable in the e-commerce platform to the second user who has instructed a product request. Points may be additionally given to the second user when the first product for which a product request has been made is purchased. In addition, even in the case where one person is able to make a product request multiple times, points should be given only within a predetermined number of times. The request processing module 237 may also give similar points to the first user who has approved the product request. In addition, the benefit to the first user may be any of other benefits, such as a free shipping fee, other than points.

Thus, benefits are offered to the second user who makes a product request or to the first user who approves the product request, and therefore the use of the product request can be promoted.

Moreover, the listing processing module 238 may also include accepting a purchase request from only another user (second user) who has instructed the product request for a predetermined period after the first user approves the listing of the requested product. For example, regarding the listing in the case where the product request is approved, the listing processing module 238 accepts a purchase or purchases of only one or more users (second user) who instructed the product request for a predetermined period (for example, one week after the approval).

As a result, the second user who instructed the product request is able to be given the right to preferentially purchase the first product.

Each of the above elements may be stored in one or more of the storage devices described above. Each of the modules described above corresponds to a set of instructions for performing the functions described above. The modules or programs (in other words, sets of instructions) described above need not be implemented as separate software programs, procedures, or modules, and thus different subsets of these modules may be combined in different embodiments, or alternatively may be reconfigured. In some embodiments, the memory 230 may store subsets of the modules and data structures described above. Furthermore, the memory 230 may store additional modules and data structures not described above.

Although FIG. 3 illustrates “server,” FIG. 3 is intended as an illustration of the various features that may be present in a set of servers, rather than as a structural overview of the embodiments described herein. In practice, items illustrated separately may be combined and some items may be separated, as will be appreciated by those skilled in the art. For example, the items illustrated separately in FIG. 3 could be implemented on a single server, and a single item could be implemented by one or more servers.

Note that one or more processing devices (CPU) 210 read and execute each module from the memory 230 as needed. For example, one or more processing devices (CPU) 210 may configure a communication unit by executing a network communication module 232 stored in the memory 230. In addition, one or more processing devices (CPU) 210 may execute the transaction management module 236, the request processing module 237, the listing processing module 238, and the purchase processing module 239 stored in the memory 230, respectively, to thereby configure a transaction management unit, a request processing unit, a listing processing unit, and a purchase processing unit. Moreover, the respective processes of the transaction management module 236, the request processing module 237, the listing processing module 238, and the purchase processing module 239 may be performed by one or more processing devices (CPU) 210.

Example of Data Structure

FIG. 4 is a diagram illustrating an example of the user data 233 according to the embodiment. The user data 233 includes information on each member user created by a person who operates and manages the e-commerce platform for management. The “user ID” includes user identification information (user ID: Identifier) for the server 20 to uniquely identify the user. The “user information” includes the personal information of the user, such as “name,” “address,” “phone number,” and the like. The user ID may be included as a piece of the user information.

FIG. 5 is a diagram illustrating an example of the transaction data 234 according to the embodiment. The “seller ID” includes the user ID of a user who is a seller. A term “product” includes a product name. A term “description” includes a description of the product category, brand, and the like. A term “price” includes a selling price of the product. In addition, “product,” “description,” and “price” may be included in the listing information of the product, and other information may be included in the listing information. A term “condition” includes the condition of the product when it is listed. The “status” includes the transaction state in the electronic commerce. The status includes “under transaction” indicating that the transaction is currently in progress, “under negotiation” indicating that negotiation with a user who is a buyer is currently in progress, “done” indicating that the product has been sold, and the like. The “purchaser ID” includes the user ID of the user who purchased the product.

FIG. 6 is a diagram illustrating an example of inventory list data 235 according to the embodiment. The inventory list data 235 illustrated in FIG. 6 lists products owned by a user identified by the user ID “U26.” The inventory list data 235 illustrated in FIG. 6 contains products such as “bag” and “clock.” Each of the products is associated with the presence or absence of a product request from another person and, if there is a product request, with the user ID of the user who sent the product request with a desired price, and the like for each product request. This makes it possible to manage which product a product request was made for, with respect to the products owned by a certain user.

The data structure described above is merely an example, and the present invention is not limited to this example. For example, regarding FIG. 5, the product data may be separated from the transaction data (status, purchaser ID, and the like) in management.

Operation Description

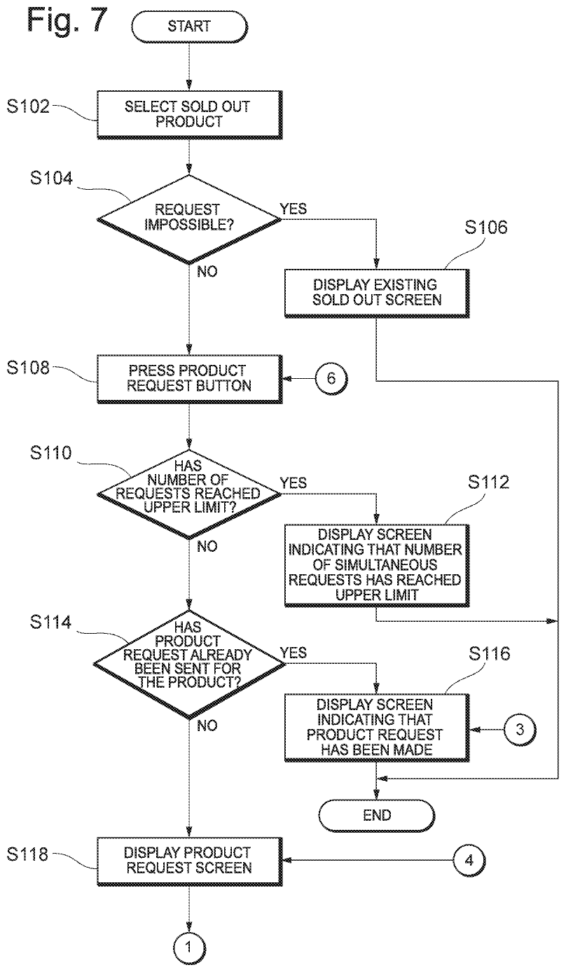

Subsequently, description will be made on the operation of the information processing system 1 according to the embodiment. FIGS. 7 to 9 are flowcharts illustrating an example of processing related to the sending of a product request according to the embodiment.

(Step S102)

The transaction control module 134 of the user terminal 10 accepts the selection of a sold-out product on the basis of a user operation.

(Step S104)

The transaction control module 134 of the user terminal 10 determines whether the product request cannot be made for the selected product or whether the acceptance of the product request is rejected. If the result is affirmative (the product cannot be listed or the request is rejected) in both determinations (step S104: YES), the processing proceeds to step S106. If the result is negative (the product can be listed, the request can be made) (step S104: NO), the processing proceeds to step S108.

Note that products that cannot be requested to be listed include foods and the like whose product conditions change over time. Regarding whether the acceptance of the product request is rejected, for example, information indicating that the product is rejected is held in association with the product in the inventory list data 235 illustrated in FIG. 6 when a user who owns the product (for example, the first user) rejects the acceptance of the product request.

(Step S106)

The display control module 137 of the user terminal 10 controls the display of an existing sold-out product. For example, the product request button is not displayed on this screen.

(Step S108)

The transaction control module 134 of the user terminal 10 detects that the product request button displayed in association with the predetermined product (first product) has been operated by a user (for example, the second user). At this time, information indicating that a product request has been made is sent to the server 20.

(Step S110)

Upon receiving the information indicating that the product request has been made for the first product, the request processing module 237 of the server 20 determines whether the number of product requests for the first product has reached the upper limit. If the number has reached the upper limit (step S110: YES), the processing proceeds to step S112. Unless the number has reached the upper limit (step S110: NO), the processing proceeds to step S114. The request processing module 237 holds a threshold value that indicates the upper limit for the number of product requests.

(Step S112)

The request processing module 237 of the server 20 sends a notification indicating that the number of product requests has reached the upper limit to the user terminal 10. The display control module 137 of the user terminal 10 performs control to display the notification indicating that the number of product requests has reached the upper limit on the screen.

(Step S114)

The request processing module 237 of the server 20 determines whether the second user has already sent a product request for the first product. If the product request has been sent (step S114: YES), the processing proceeds to step S116. Unless the product request has been sent (step S114: NO), the processing proceeds to step S118.

(Step S116)

The request processing module 237 of the server 20 sends a notification indicating that the product request has already been made to the user terminal 10. The display control module 137 of the user terminal 10 performs control to display the notification, indicating that the product request has already been made, on the screen.

(Step S118)

The request processing module 237 of the server 20 sends the screen information of the product request screen to the user terminal 10. The display control module 137 of the user terminal 10 performs control to display the screen information of the product request screen.

(Step S120)

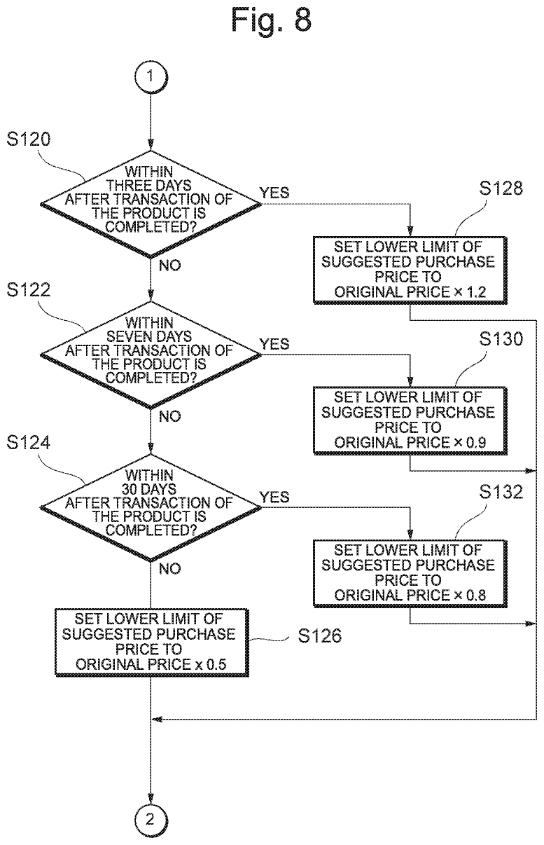

As illustrated in FIG. 8, the request processing module 237 of the server 20 determines whether the product request received date is within three days after the first product transaction is completed. If the date is within three days after the transaction is completed (step S120: YES), the processing proceeds to step S128. If the period after the transaction is completed exceeds three days (step S120: NO), the processing proceeds to step S122.

(Step S122)

The request processing module 237 of the server 20 determines whether the product request received date is within seven days after the first product transaction is completed. If the date is within seven days after the transaction is completed (step S122: YES), the processing proceeds to step S130. If the period after the transaction is completed exceeds seven days (step S122: NO), the processing proceeds to step S124.

(Step S124)

The request processing module 237 of the server 20 determines whether the product request received date is within 30 days after the first product transaction is completed. If the date is within 30 days after the transaction is completed (step S124: YES), the processing proceeds to step S132. If the period after the transaction is completed exceeds 30 days (step S124: NO), the processing proceeds to step S126.

(Step S126)

The request processing module 237 of the server 20 sets the lower limit of the suggested purchase price of the first product (first price information) to the original price (the price at which the first user purchased the product)×0.5.

(Step S128)

The request processing module 237 of the server 20 sets the lower limit of the suggested purchase price of the first product to the original price (the price at which the first user purchased the product)×1.2.

(Step S130)

The request processing module 237 of the server 20 sets the lower limit of the suggested purchase price of the first product to the original price (the price at which the first user purchased the product)×0.9.

(Step S132)

The request processing module 237 of the server 20 sets the lower limit of the suggested purchase price of the first product to the original price (the price at which the first user purchased the product)×0.8.

(Step S134)

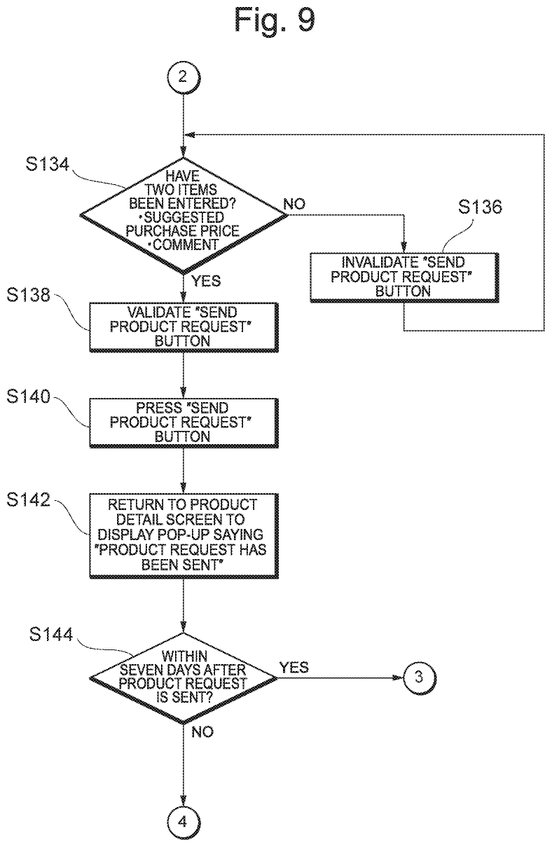

As illustrated in FIG. 9, the transaction control module 134 of the user terminal 10 determines whether or not the second user has entered a suggested purchase price of the product request and a comment related to the product request from the product request screen. If the suggested purchase price and the comment has been entered (step S134: YES), the processing proceeds to step S138. Unless either suggested purchase price or comment has been entered (step S134: NO), the processing proceeds to step S136.

(Step S136)

The transaction control module 134 of the user terminal 10 controls the “send product request button” on the product request screen to be invalidated. The processing returns to step S134.

(Step S138)

The transaction control module 134 of the user terminal 10 controls the “send product request button” on the product request screen to be validated.

(Step S140)

The transaction control module 134 of the user terminal 10 detects that the user (second user) has operated the button for sending the product request displayed on the product request screen. At this time, the product request is sent to the server 20 along with information indicating a purchase amount (second price information) and a comment.

(Step S142)

The display control module 137 of the user terminal 10 performs control to return to the product detail screen of the first product and to display the pop-up screen of “product request has been sent.”

(Step S144)

The transaction control module 134 of the user terminal 10 determines whether it is within seven days after the previous product request is sent. If it is within seven days after the previous product request is sent (step S144: YES), the processing proceeds to step S116. If seven days have passed after the previous product request is sent (step S144: NO), the processing returns to step S118.

With the above processing, product requests can be sent only for predetermined products with respect to the sending of product requests, a user's desired price can be input at the time of making a product request, and the desired price of the product can be set on the server 20 side. Since the screen transition is an example, the screen may be configured to return to the home screen by clicking a close button or the like on each screen.

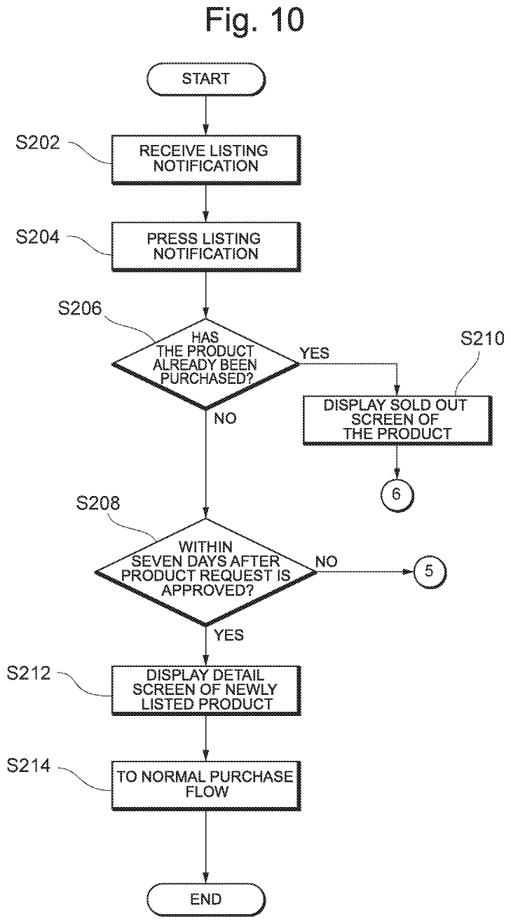

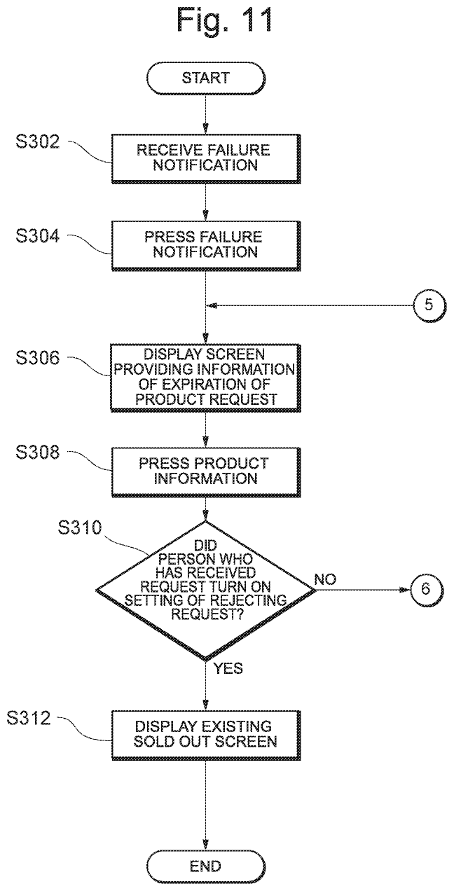

FIGS. 10 to 11 are flowcharts illustrating an example of the processing related to the result of the product request according to the embodiment. FIG. 10 illustrates processing performed when the user who accepted the product request (first user) approved the product request.

(Step S202)

The transaction control module 134 of the user terminal 10 acquires a notification indicating that the first product was listed from the server 20. The display control module 137 performs control to display this notification on the pop-up screen, on a notice list, or the like.

(Step S204)

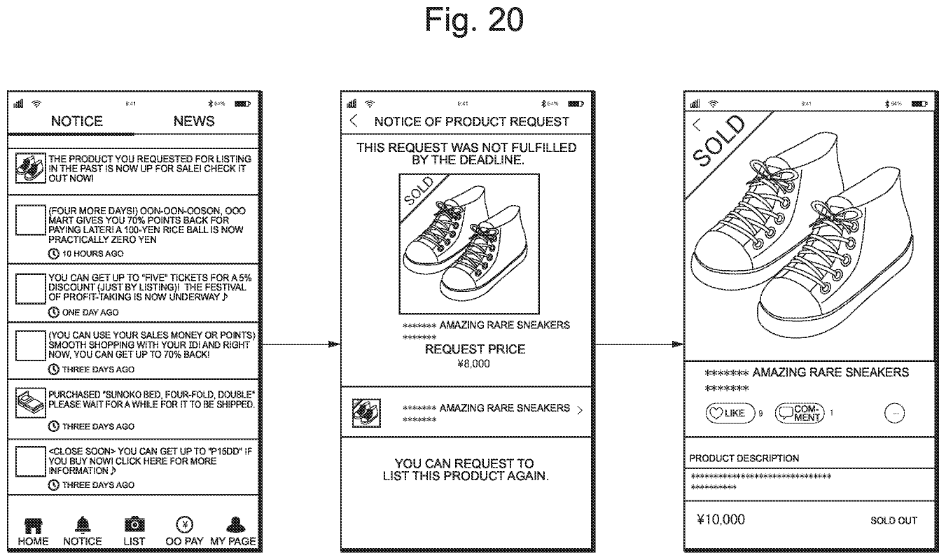

The transaction control module 134 of the user terminal 10 detects that the user (second user) operated a notice button (not illustrated) of the listing notification on the pop-up screen or on the notice list. At this time, a request for displaying a listing screen for the first product is sent to the server 20. Alternatively, the request for displaying the listing screen may be sent to the server 20 by tapping the notice list illustrated in FIG. 20.

(Step S206)

The purchase processing module 239 of the server 20 determines whether or not the first product has already been purchased. If the first product has been purchased (step S206: YES), the processing proceeds to step S210. Unless the first product is purchased (step S206: NO), the processing proceeds to step S208.

(Step S208)

The purchase processing module 239 of the server 20 determines whether it is within seven days after the product request is approved. If it is within seven days after the product request is approved (step S208: YES), the processing proceeds to step S212. If seven days have passed after the product request is approved (step S208: NO), the processing returns to step S306 illustrated in FIG. 11.

(Step S210)

The purchase processing module 239 of the server 20 sends the screen information of the sold-out screen of the first product to the user terminal 10, and the display control module 137 of the user terminal 10 performs control to display the sold-out screen of the first product. Thereafter, the processing proceeds to step S108 illustrated in FIG. 7. If the product has already been purchased, the sold-out screen of the first product may be displayed and then the processing may be terminated.

(Step S212)

The purchase processing module 239 of the server 20 sends the screen information of the product screen of a newly listed first product to the user terminal 10, and the display control module 137 of the user terminal 10 performs control to display the detail screen of the first product. The user terminal 10 may acquire the product information of the first product from the server 20 and may display the product information on the screen.

(Step S214)

The purchase control module 136 of the user terminal 10 controls the normal purchase processing according to a user operation.

With the above processing, the listing notification is accepted as a response to the sending of the product request, thereby enabling the purchase processing to be performed in a series of processes from the notification and improving the processing efficiency.

FIG. 11 illustrates processing performed in the case where the first user abandons or rejects the request.

(Step S302)

The transaction control module 134 of the user terminal 10 acquires a failure notification for the product request from the server 20. The display control module 137 performs control to display this failure notification on a pop-up screen, on a notice list, or the like. For example, the failure notification is performed after a predetermined period of time has passed from the product request or in the case where the listing is canceled by the first user who owns the first product. In the following, it is assumed that the failure notification has been sent after a lapse of a predetermined period of time after the product request is made.

(Step S304)

The transaction control module 134 of the user terminal 10 detects that the user (second user) has operated the notice button of the failure notification. At this time, information indicating that the failure notification button was pressed is sent to the server 20.

(Step S306)

Upon acquiring the information indicating that the failure notification button is pressed, the transaction management module 236 of the server 20 makes control to notify the user terminal 10 of that the product request is expired. The display control module 137 of the user terminal 10 performs control to display the screen for providing information of the expiration of the product request.

(Step S308)

The transaction control module 134 of the user terminal 10 detects that the user (second user) has operated the product information part of the first product in the screen that gives information of the expiration. At this time, the request for displaying the product information for the first product is sent to the server 20.

(Step S310)

Upon acquiring the request for displaying the product information for the first product, the request processing module 237 of the server 20 determines whether the first user who owns the first product has set the rejection of the product request. If the rejection is set (step S310: YES), the processing proceeds to step S312. Unless the rejection is set (step S310: NO), the processing proceeds to step 108 illustrated in FIG. 7.

(Step S312)

The display control module 137 of the user terminal 10 performs control to display an existing sold-out product screen. For example, the product request button is not displayed on this screen.

With the above processing, the user (second user) can be informed of the result of the failure in the product request. In the case where the reason for the failure is the rejection setting by the user (first user), the processing may proceed to step S304 and then to step S312.

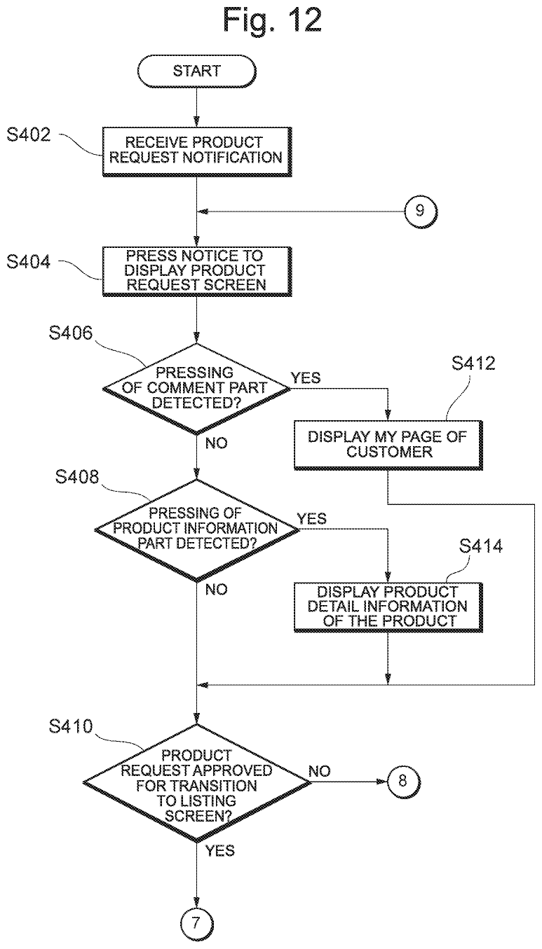

FIGS. 12 to 14 are flowcharts illustrating examples of processing related to the reception of a product request according to the embodiment. FIG. 12 illustrates an example of processing of approving the product request and listing the product.

(Step S402)

The transaction control module 134 of the user terminal 10 acquires the notification indicating that the product request was made for the first product from the server 20. The display control module 137 performs control to display this notification on a pop-up screen or in a notice list.

(Step S404)

The transaction control module 134 of the user terminal 10 detects that the user (first user) has operated the notice button of the product request notification. At this time, a request for displaying the product request screen for the first product is sent to the server 20. The request processing module 237 of the server 20 acquires the request for displaying the product request screen and sends the information on the product request made for the first product to the user terminal 10. The display control module 137 of the user terminal 10 performs control to display the product request screen.

(Step S406)

The transaction control module 134 of the user terminal 10 determines whether or not the user (first user) has operated the comment part on the product request screen. If the comment part is pressed (step S406: YES), the processing proceeds to step S412. Unless the comment part is pressed (step S406: NO), the processing proceeds to step S408.

(Step 408)

The transaction control module 134 of the user terminal 10 determines whether or not the user (first user) has operated the previous product information part on the product request screen. If the product information part is pressed (step S408: YES), the processing proceeds to step S414. Unless the product information part is pressed (step S408: NO), the processing proceeds to step S410.

(Step S410)

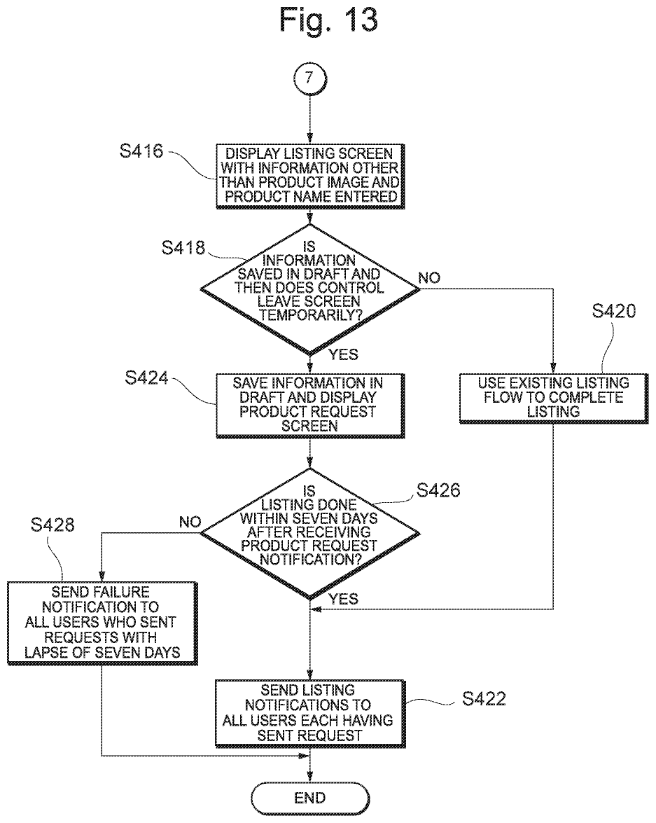

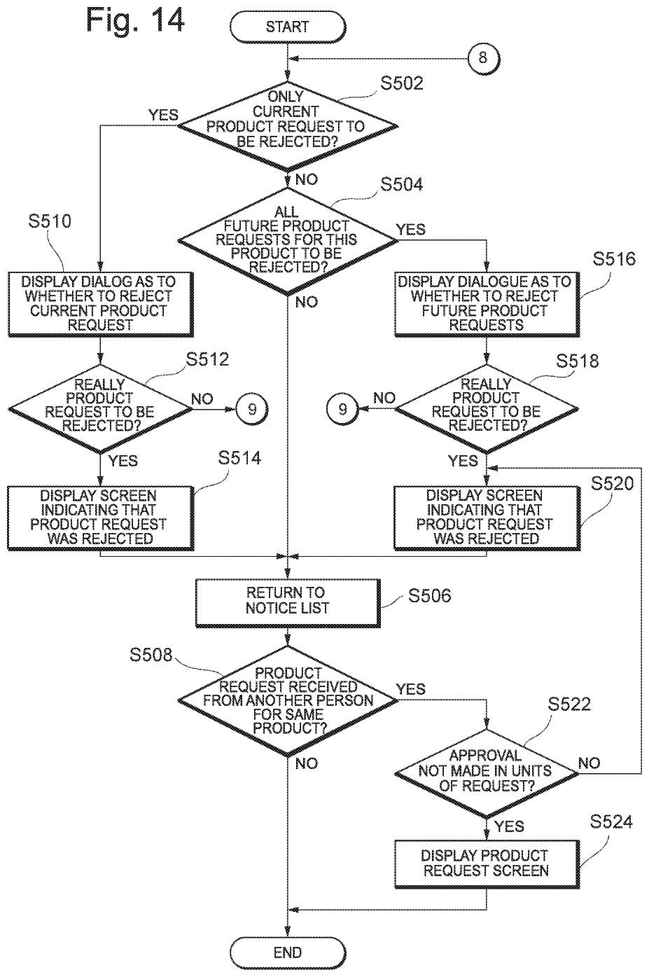

The transaction control module 134 of the user terminal 10 determines whether or not the user (first user) operated the button for approving the listing on the product request screen. If the approval button is pressed (step S410: YES), the processing proceeds to step S416 illustrated in FIG. 13. Unless the approval button is pressed (step S410: NO), the processing proceeds to step S502 illustrated in FIG. 14.

(Step S412)

The display control module 137 of the user terminal 10 performs control to display my page including at least a part of the user information of the first user.

(Step S414)

The display control module 137 of the user terminal 10 performs control to display the detail screen including the product information of the first product.

(Step S416)

As illustrated in FIG. 13, the display control module 137 of the user terminal 10 performs control to display the listing screen with information other than the product image and product name entered.

(Step S418)

In response to a user operation, the transaction control module 134 of the user terminal 10 determines whether or not to save the information in the draft (predetermined storage area) and then to leave the listing screen temporarily. If the control temporarily leaves the listing screen (step S418: YES), the processing proceeds to step S424. Unless the control leaves the listing screen (step S418: NO), the processing proceeds to step S420.

(Step S420)

The listing control module 135 of the user terminal 10 uses existing listing processing to cause the predetermined information to be entered to complete the listing processing. The listing information for the first product is sent to the server 20.

(Step S422)

Upon detecting that the listing for the product request has been made, the request processing module 237 of the server 20 performs control to send listing notifications to all users who each have made a product request for this product.

(Step S424)

The listing control module 135 of the user terminal 10 saves the input information on the first product in the draft, and the display control module 137 displays the product request screen.

(Step S426)

The listing control module 135 of the user terminal 10 determines whether or not the listing has been done within seven days after saving the draft. If the listing is done within seven days (step S426: YES), the processing proceeds to step S422. Unless the listing is done within seven days (step S416: NO), the processing proceeds to step S428.

(Step S428)

Upon detecting that the listing has not been done within seven days after the product request, the request processing module 237 of the server 20 performs control to send a failure notification to the user who made the product request for this product. In addition, in the case of detecting that the listing has not been done within seven days after receiving the first product request notification, the request processing module 237 may apply control to send a failure notification to all users.

FIG. 14 illustrates processing performed in the case where the first user rejects the product request.

(Step S502)

The transaction control module 134 of the user terminal 10 determines whether to reject only the current product request on the basis of the user operation. If only the current product request is rejected (step S502: YES), the processing proceeds to step S510. Unless only the current product request is rejected (step S502: NO), the processing proceeds to step S504.

(Step S504)

Based on the user operation, the transaction control module 134 of the user terminal 10 determines whether to reject all future product requests for this product (first product). If all product requests are to be rejected (step S504: YES), the processing proceeds to step S516. Unless all product requests are to be rejected, the processing proceeds to step S506.

(Step S506)

The transaction control module 134 of the user terminal 10 controls the screen to return to the notice list on the basis of the user operation.

(Step S508)

The transaction control module 134 of the user terminal 10 determines whether another user has made a product request for the same product (first product). If another user has made a product request (step S508: YES), the processing proceeds to step S522. Unless another user has made the product request (step S508: NO), the processing ends.

(Step S510)

The display control module 137 of the user terminal 10 performs control to display a dialog (UI screen) as to whether to reject the current product request.

(Step S512)

The display control module 137 of the user terminal 10 performs control to display the UI component that indicates whether to really reject the product request to ask the first user. If the product request is rejected (step S512: YES), the processing proceeds to step S514. Unless the product request is rejected (step S512: NO), the processing proceeds to step S404 illustrated in FIG. 12.

(Step S514)

The display control module 137 of the user terminal 10 performs control to display the screen indicating that the product request was rejected. At this time, this screen may include a link to future request rejection settings.

(Step S516)

The display control module 137 of the user terminal 10 performs control to display a dialogue (UI screen) as to whether to reject future product requests.

(Step S518)

The display control module 137 of the user terminal 10 performs control to display the UI component that indicates whether to really reject the product request to ask the first user for confirmation. If the product request is rejected (step S518: YES), the processing proceeds to step S520. Unless the product request is rejected (step S518: NO), the processing proceeds to step S404 illustrated in FIG. 12.

(Step S520)

The display control module 137 of the user terminal 10 performs control to display the screen indicating that the future product requests are rejected. At this time, this screen may include a link to the settings for restarting the acceptance of product requests.

(Step S522)

In the case where a product request is received from another person for the same product, the transaction control module 134 of the user terminal 10 determines whether or not an approval was made in units of a product request on the basis of the user operation. If the request is approved in units of a request (step S522: YES), the processing proceeds to step S524. Unless the request is approved in units of a request (step S522: NO), the processing proceeds to step S520.

(Step S524)

The display control module 137 of the user terminal 10 performs control to display the product request screen for comparing the respective product requests received from a plurality of persons with each other.

Through the above processing, the first user who owns the first product is able to select whether to list the product or reject the product request when receiving the notification that the product request has been made. If the user list the product, the user is able to list the product with a series of processes, thereby increasing the efficiency of the processing.

Screen Example

Subsequently, a screen example of the user terminal 10 will be described. FIGS. 15 to 17 are diagrams illustrating examples of a screen displaying product request buttons according to the embodiment.

FIG. 15 illustrates an example of product request buttons displayed on the sold-out screen. The left-hand screen illustrated in FIG. 15 is a screen on which products are available for sale. If a user operates a sold-out tab, the right-hand screen illustrated in FIG. 15 is displayed.

In the example on the right screen illustrated in FIG. 15, a list of sold-out products is displayed on the screen, and a product request button may be displayed for each product. In the case where the owner of the product rejects a product request, the product request button may not be displayed for the product.

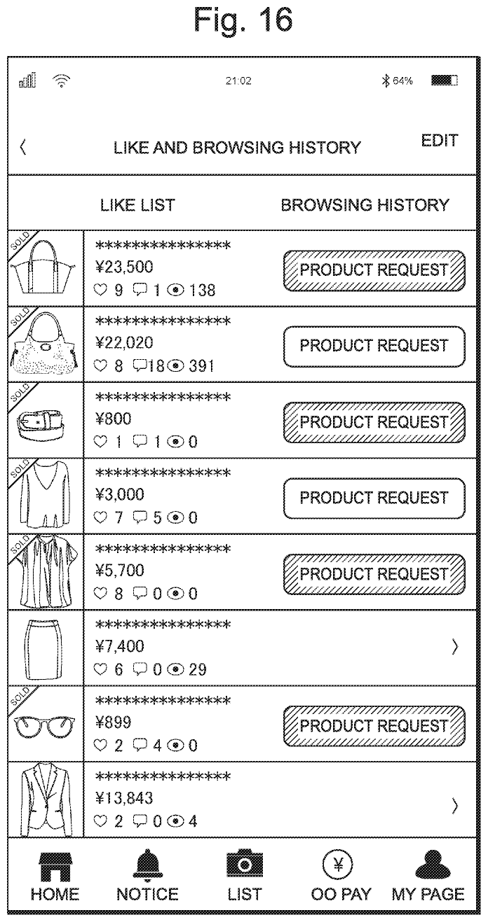

FIG. 16 illustrates an example in which the product request buttons are displayed for the sold-out products with respect to products for which the user has set “like.” In the example illustrated in FIG. 16, when the “Like List” tab is selected by the user, a list of products for which the user has set “Like” in the past is displayed. At this time, if a product is sold-out and the product request is not rejected by the owner of the product, a product request button is displayed in association with the product. Moreover, if the product request is rejected, an invalidated product request button may be displayed. The request processing module 237 of the server 20 acquires whether or not the product request is rejected for the product and determines whether the product request button is valid or invalid. The request processing module 237 sends the determined information to the user terminal 10. This makes it possible to display the screen illustrated in FIG. 16.

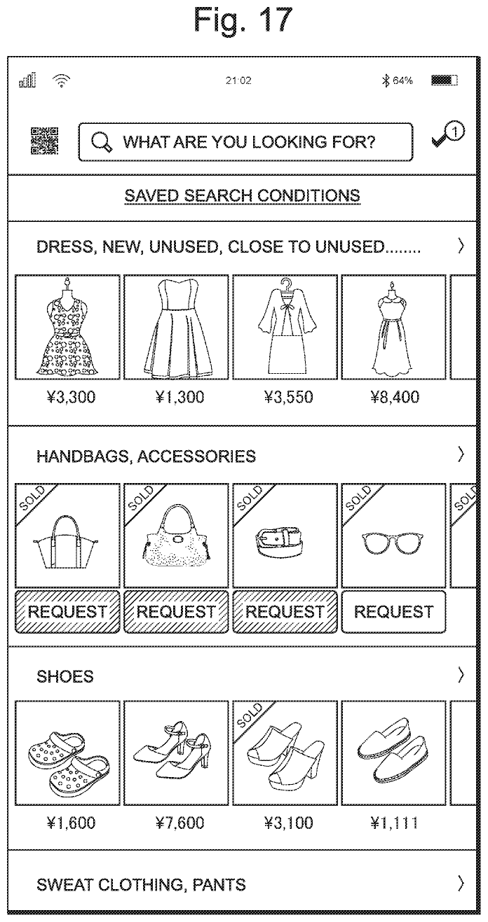

FIG. 17 illustrates an example in which product request buttons are displayed for the products hit by the saved search conditions. In the example illustrated in FIG. 17, if the user selects the “Saved search conditions” tab, a list of products found under the search conditions saved by the user is displayed. In the same manner as in FIG. 16, if a product is sold out and unless the owner of the product rejects the product request, a product request button is displayed in association with the product. Description of the display of the invalidated product request button is the same as the content described in FIG. 16.

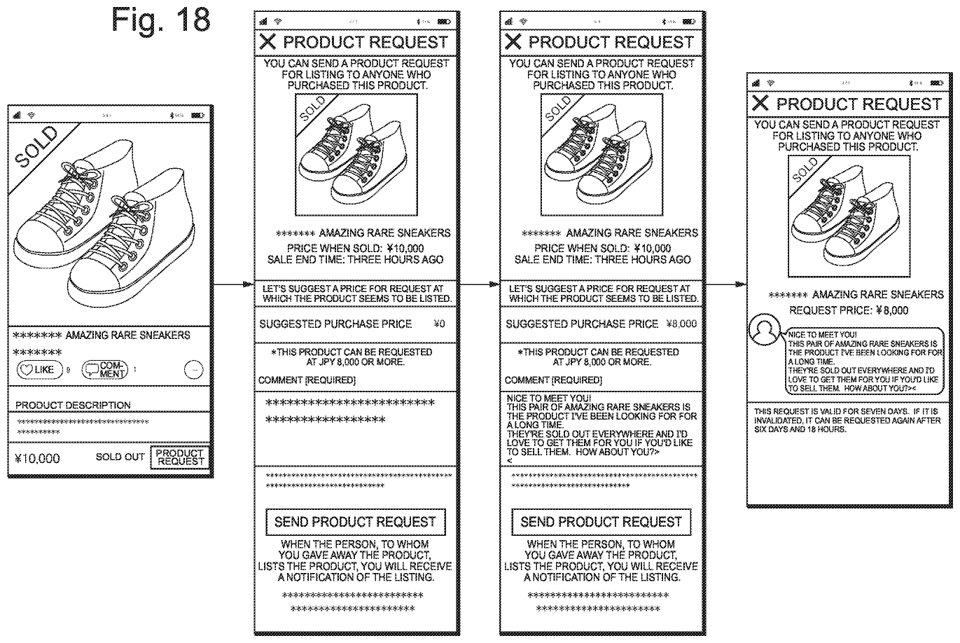

FIG. 18 is a diagram illustrating a screen transition example for a case where a product request according to the embodiment is made. In the example illustrated in FIG. 18, a product request button is displayed on the sold-out product screen. If the user (second user) presses this product request button, the product request screen is displayed.

The product request screen example illustrated in FIG. 18 includes a suggested purchase price entry field and a comment entry field in which the user enters information. The user can enter each information by selecting each entry field. It is assumed that the user enters 8,000 yen as a suggested purchase price and “Nice to meet you!” as a comment.

The entered request screen example illustrated in FIG. 18 is displayed with the suggested purchase price and comments entered by the user reflected. The user confirms the entered content and presses the “Send product request” button. Thereupon, the product requested screen is displayed.

In the example of the product requested screen illustrated in FIG. 18, the screen displays information that the product request has been sent, the valid period of the product request, and the procedure required when it is invalidated. This enables the user to confirm that the product request has already been sent.

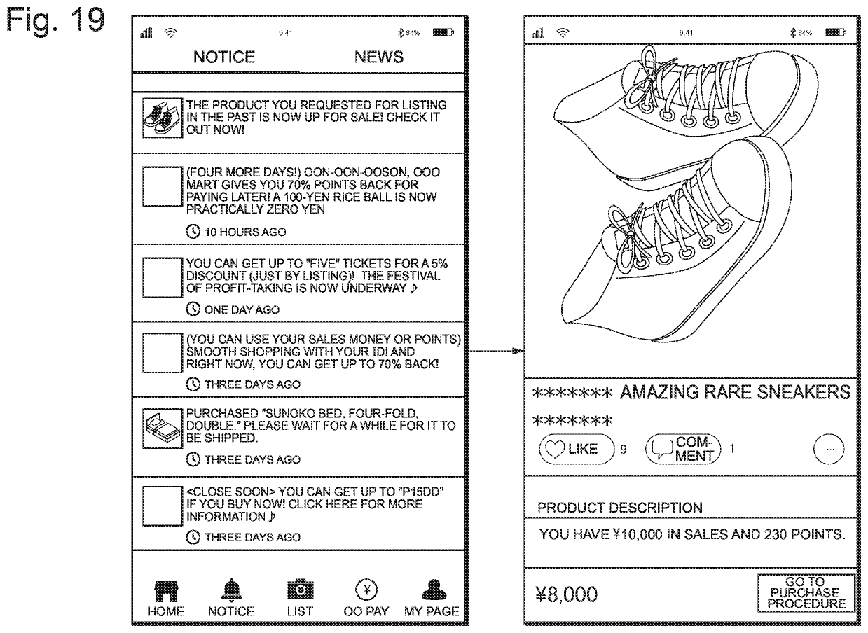

FIG. 19 is a diagram illustrating a screen transition example for a case where the product request according to the embodiment was approved. In the example illustrated in FIG. 19, when the owner of the product (first user) approved the product request, the user who has sent the product request (second user) is notified of that the product request was approved. The user terminal 10 performs control to display this notification in the notice list as illustrated in FIG. 19, for example. If the second user presses this notification part, a listing screen where the first product is listed anew is displayed.

As illustrated in FIG. 19, a user who sent the product request receives from the server 20 a notification indicating that the product request was approved for the product and that the product was listed, and thereupon the user is able to perform purchasing processing of the product with a simple operation.

FIG. 20 is a diagram illustrating a screen transition example for a case where the product request according to the embodiment is abandoned. In the example illustrated in FIG. 20, if the owner (first user) of the product abandons the product request, the product request ends in failure. In this situation, the user (second user) who sent the product request is notified of the failure in the product request. The user terminal 10 performs control to display the failure notification in the notice list as illustrated in FIG. 20, for example. When the second user presses this failure notification part, the first product failed in the product request is displayed on the screen.

When the second user requests the detail screen of the first product, the screen containing the product information of the first product is displayed as illustrated in FIG. 20. In this situation, if the product request is rejected by the first user, the product request button is not displayed. Unless the product request is rejected by the first user, the same screen as the sold-out screen illustrated in FIG. 18 is displayed.

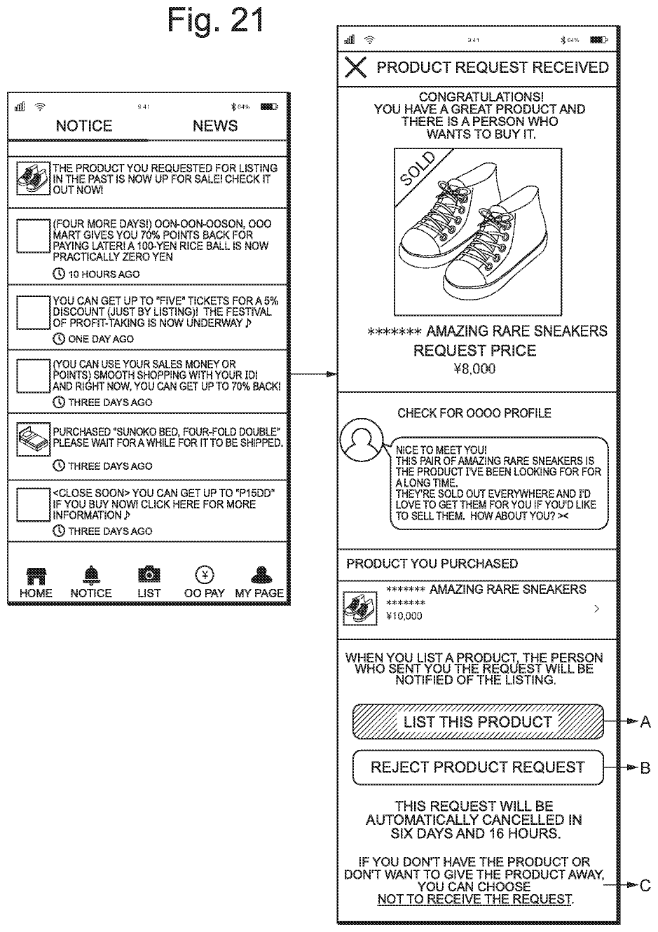

FIGS. 21 to 24 are diagrams illustrating a screen transition example for a case of having received a product request according to the embodiment. In the example illustrated in FIG. 21, the user (first user) who has received the product request is notified of that the product request was accepted. The user terminal 10 performs control to display this notification in the notice list as illustrated in FIG. 21, for example. When the first user pressed this notification part, the detail screen of the product request is displayed.

As illustrated in FIG. 21, for example, the detail screen of the product request includes which product it is among the products that the first user owns, how much the desired price is, and which user wants to purchase the product. Furthermore, in order to give the first user options for a response to the product request such as, for example, listing the product (A), rejecting the product request (B), rejecting the subsequent product requests (C), and the like, UI components (buttons or links) indicating the options are displayed on the screen.

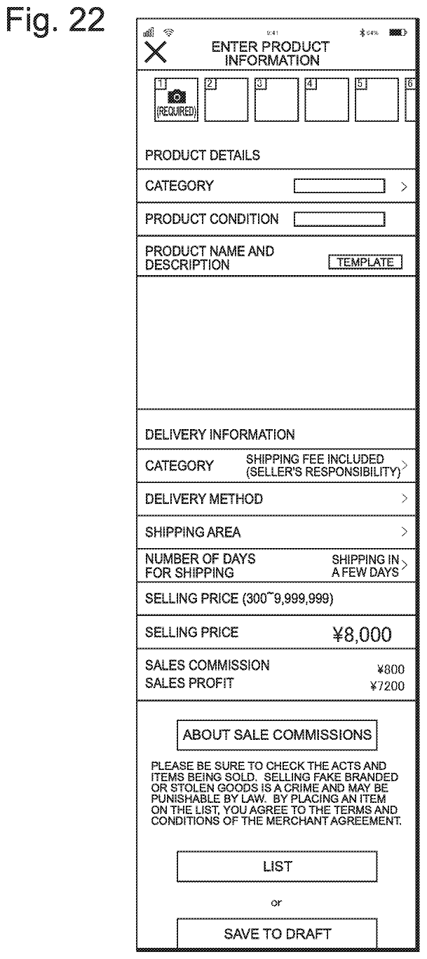

FIG. 22 illustrates an example of a listing screen that is displayed in the case where the “List this product” button illustrated in FIG. 21 is pressed. In the example illustrated in FIG. 22, if there is past listing information other than the product image and condition, the information may be diverted. Regarding the price, the desired price set by the second user is entered by default and can be changed by the first user. In addition, the listing screen displays a “List” button for listing the product by using the listing information, and a “Save to draft” button for temporarily saving information and then leaving this screen.

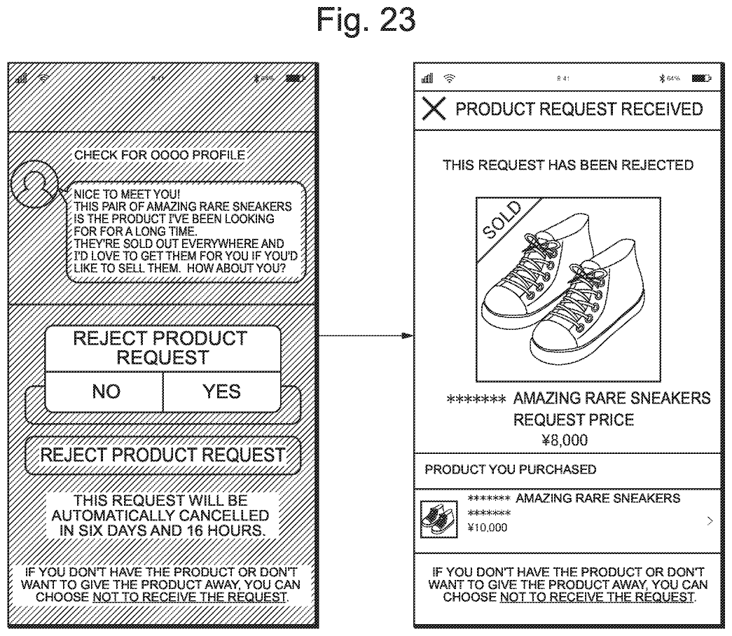

FIG. 23 illustrates a screen transition example displayed when the “Reject product request” button illustrated in FIG. 21 is pressed. In the example illustrated in FIG. 23, a dialog is displayed for the first user to confirm that the first user really wants to reject the product request. If the user presses “Yes” in this dialog, a screen is displayed stating that the product request was rejected.

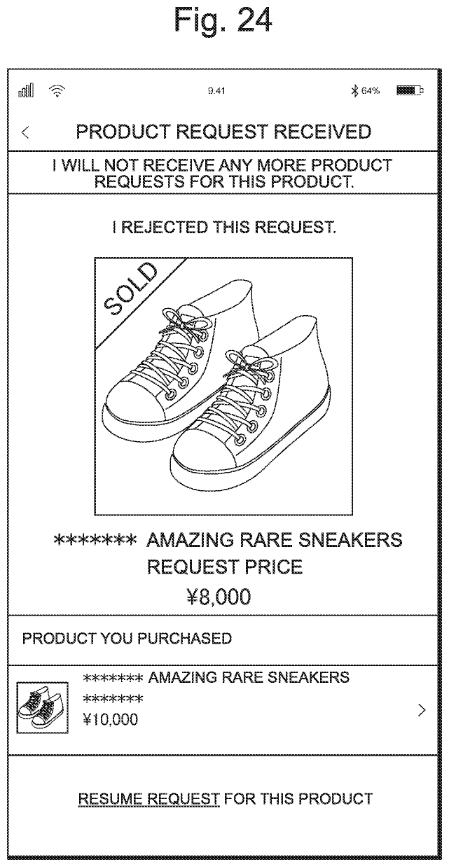

FIG. 24 illustrates a screen example displayed when the “Not to receive the request” link illustrated in FIG. 21 is selected and a setting is made not to receive a product request at the link destination. In the example illustrated in FIG. 24, it is displayed that the user does not receive future product requests for the product. In some cases, the user may want to receive a product request again, and therefore a setting for receiving a product request is enabled. For example, in the example illustrated in FIG. 24, a setting can be made so that a “Resume request” link is displayed on the screen and the first user presses this link to receive a product request on the link destination setting screen.

The disclosed technology is not limited to the above embodiments, and can be implemented in various other forms without departing from the gist of the disclosed technology. Therefore, the above embodiments are merely examples in all respects, and should not be interpreted as limited. For example, the processing steps described above can be arbitrarily changed in order or executed in parallel as long as the processing contents do not conflict with each other.

The programs of the embodiments of the present disclosure may be provided in a state of being stored in a computer-readable storage medium. The storage medium can store the programs in a “non-transitory tangible medium.” The programs include, by way of example and not limitation, software programs and computer programs.

Modification

Furthermore, a modification of the above embodiments will be described below. In the modification, the price displayed on the screen in the above embodiments may be the price after the commission on the e-commerce platform is subtracted. The price displayed on the screen may be the price after the expected shipping fee is subtracted. Moreover, the user terminal 10 is able to display the same screens as the above screens, independently of whether the screen is an application screen or a screen using a web browser.

### CROSS-REFERENCE OF RELATED APPLICATIONS

### Description of Symbols

1 Information processing system
10, 10A, 10B Information processing device (user terminal)
20 Information processing device (server)
110, 210 Processing device (CPU)
120, 220 Network communication interface
130, 230 Memory
131, 231 Operating system
132, 232 Network communication module
133 Application data
134 Transaction control module
135 Listing control module
136 Purchase control module
137 Display control module
150 User interface
160 Imaging device
170, 270 Communication bus
233 User data
234 Transaction data
235 Inventory list data
236 Transaction management module
237 Request processing module
238 Listing processing module
239 Purchase processing module

What is claimed is:

1. An information processing method wherein one or more processors included in an information processing device perform the processes of:
acquiring a product request made from another user for an unlisted first product on an e-commerce platform that is the first product owned by a first user;
associating the product request with information on the first product;
notifying the information processing device used by the first user of information indicating that there has been made the product request for the first product; and
performing listing processing of the first product on the e-commerce platform in the case where there is a listing order for the first product from the first user.

2. The information processing method according to claim 1, wherein the first product includes a product purchased by the first user on the e-commerce platform or another e-commerce platform.

3. The information processing method according to claim 1, wherein performing the listing processing includes using at least some of the product information associated with the first product when the first user purchased the first product for the listing information of the first product.

4. The information processing method according to claim 1, wherein the notifying includes further notifying first price information indicating a desired price of the first product at the time of listing the first product.

5. The information processing method according to claim 4, wherein the one or more processors further perform the process of changing the desired price on the basis of a period after the first user purchased the first product.

6. The information processing method according to claim 5, wherein:
the acquiring includes acquiring second price information indicating a user's desired price along with the product request; and
the notifying includes making a notification of the information indicating that the product request was made in the case where the user's desired price is equal to or more than the desired price.

7. The information processing method according to claim 1, wherein the acquiring includes acquiring product requests from one or more other users until the first user approves the product request for the first product.

8. The information processing method according to claim 1, wherein the notifying includes notifying information processing devices used by respective users associated with the first product as users who are interested in the first product of information on the listing of the first product, in the case where the first user approved the product request for the first product.

9. The information processing method according to claim 1, wherein one or more processors perform control to display a UI component that enables the acceptance of the product request on another information processing device, in the case where the unlisted first product is displayed on the another information processing device used by the another user.

10. The information processing method according to claim 1, wherein the process of performing the listing processing includes completing a transaction for the first product with the another user in the case where the listing order has been made.

11. The information processing method according to claim 1, wherein the acquiring includes setting an upper limit for the product request to be acquired.

12. The information processing method according to claim 1, wherein the one or more processors further perform the process of giving benefit information to other users who instructed the product requests or to the first user who approved the product request.

13. The information processing method according to claim 1, wherein the process of performing the listing processing includes accepting a purchase request only from other users who instructed the product requests for a predetermined period after the first user approved the listing.

14. A computer-readable non-transitory storage medium storing a program for causing one or more processors included in an information processing device to perform:
acquiring a product request made from another user for an unlisted first product on an e-commerce platform that is the first product owned by a first user;
associating the product request with information on the first product;
notifying the information processing device used by the first user of information indicating that there has been made the product request for the first product; and
performing listing processing of the first product on the e-commerce platform in the case where there is a listing order for the first product from the first user.

15. An information processing device comprising one or more processors, wherein the one or more processors perform the processes of:
acquiring a product request made from another user for an unlisted first product on an e-commerce platform that is the first product owned by a first user;
associating the product request with information on the first product;
notifying the information processing device used by the first user of information indicating that there has been made the product request for the first product; and
performing listing processing of the first product on the e-commerce platform in the case where there is a listing order for the first product from the first user.
